(19) United States
(12) Patent Application Publication
(10) Pub. No.: US 2014/0352156 A1
(43) Pub. Date: Dec. 4, 2014

(54) CUTTING HAND TOOL

(71) Applicant: Thomas Jay Landwehr, Green Bay, WI (US)

(72) Inventor: Thomas Jay Landwehr, Green Bay, WI (US)

(21) Appl. No.: 13/906,427

(22) Filed: May 31, 2013

(51) Int. Cl. B26B 1/08

(52) U.S. Cl. CPC B26B 1/08
USPC 30/162

(57) ABSTRACT

A cutting hand tool which allows easy cutting of thin materials, such as film, paper, packaging or other flexible materials even if the material is folded or stretchy such as shrink- or stretch-wrap, without requiring a strong force, while at the same time protecting the user from injuries. The cutting blade is placed in a recess to prevent accidents and can be rotated or laterally moved by activating a trigger so that an additional force can be applied to cut the material whenever this is required to continue the cutting motion, when the material is rolled over, folded, bunched or reinforced and therefore requires an additional cutting force.

### FIELD OF THE INVENTION

The present invention relates to a cutting hand tool for cutting thin materials, such as film, paper, packaging or other flexible materials with a blade, which is placed in a recess to prevent accidents.

### BACKGROUND OF THE INVENTION

A large variety of hand tools for cutting thin materials, such as film, paper, packaging or other flexible materials have been developed in the past and are currently available in the market. The most common tools can be grouped into three groups: scissors, utility knives and concealed blade cutters. The cutting process is different for each group.

Scissors usually perform a cutting action by moving two cutting blades towards each other and towards the material without any relative movement of the material to the tool. Cutting with scissors generally starts at one edge of the material. If the material is to be cut from an intermediate position an initial opening must be created to allow one of the blades to pass to the other side of the material. During the cut one blade is often essentially stationary while the second blade is made to move towards the material by an action similar to making a fist at the opposite end of the scissors. The location where the two cutting edges of the blades meet moves along the material as the scissors are closed and the material is cut by the two cutting edges passing each other. If the length of the cut exceeds the length of the cutting blades the scissors need to be reopened and the cutting process is repeated.

When a utility knife is used for cutting, the cut can be initiated either on the edge of the material or at any other spot. To start the cut at an intermediate position a hole is punctured with the sharp tip of the blade. The cut is then continued for as long as necessary by guiding the blade along the material, usually with a handle which is held in the hand. Depending on the strength of the material the force and speed required for cutting the material need to be adjusted.

With concealed blade cutters, the blade is positioned in a holder such that the cutting edge is located in a small recess that prevents making contact with the blade with the fingers or other body parts. The cutting action can be initiated on the edge of the material or at any other point, if the cutter is equipped with a sharp point on one side of the recess allowing the material to be punctured. Once the cut is started, it can be continued by guiding the cutter along the material in the same manner as with a utility knife. The blade however is not exposed, to prevent accidental cutting of the arms, hands or any other body part of the operator.

These three cutting tool groups all have advantages and disadvantages. From a safety perspective when using scissors, one essentially has 2 open blades, which can be hazardous, except if special guards are attached to the blades as taught in EP0942812. Also, when cutting shrink or stretch-wrap off of palletized loads, it is very cumbersome to start on either the top or bottom of the load using scissors. Depending on the size of the load a step ladder would be required to start at the top and starting at the bottom may not be possible due to the configuration of the load. The alternative would be to puncture a hole in the center of the wrapping and first cutting upwards and then downwards, to sever all the wrapping off a vertical load. Given the stretchability of shrink or stretch-wrap puncturing a hole with scissors may not be easily possible and the items underneath the wrappings may be damaged while puncturing the hole.

With a utility knife it is easier to start on either end of the load to cut the wrappings off, since the access to one side of the material is sufficient. Also starting a cut at an intermediate position is easy, but anything underneath the wrappings can easily be damaged by the open tip of the blade. Use of a utility knife can lead to an increased risk of injury if the cutter slips off the material.

To prevent the aforementioned risk of injury, concealed blade cutters were developed, where the blade is placed in a recess that is small enough to prevent fingers or other body parts from accidentally coming into contact with the blade. The opening in a concealed blade cutter however can become completely blocked if the material bunches together before the cut is initiated or even during the cut. This is a quite common issue with stretchy materials such as shrink or stretch-wrap. A further development of such a concealed blade cutter as shown in U.S. Pat. No. 5,737,842 provides surfaces in the recess with a special geometry, such that the material is bent increasing the stiffness of the material. This stiffening of the material immediately before reaching the blade effectively prevents bunching and folding of the material. However for materials already containing multiple layers or if the material is reinforced at the edges by a seam or by a scrim throughout the material, the material cannot be cut easily with such a concealed blade cutter as the required pulling force would be very high.

### SUMMARY OF THE INVENTION

The main object of the present invention is to provide an improved cutting hand tool which allows easy cutting of thin materials, even if the material is folded or stretchy such as shrink or stretch-wrap, without requiring a strong force, while at the same time protecting the user from injuries.

### BRIEF DESCRIPTION OF THE DRAWINGS

In the drawing

FIG. 1 is a front view of the cutting hand tool.

FIG. 2 is a view of the cutting tool with the top of the front part of the housing removed.

### DETAILED DESCRIPTION OF THE INVENTION

A preferred embodiment of a cutting hand tool is described according to the drawings. This preferred embodiment is to be understood as an exemplary embodiment and any detailed description shall not be interpreted as limiting. Alternate embodiments obvious to one skilled in the art will not be described in detail or will be omitted to prevent the relevant details of the invention to be overlooked.

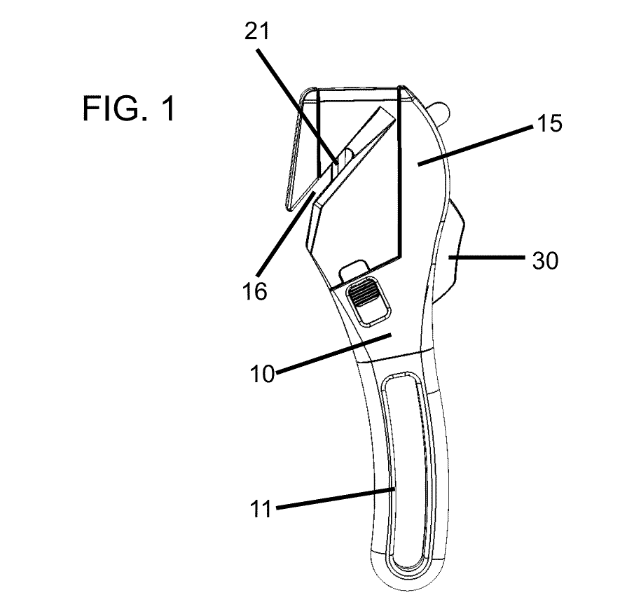

FIG. 1 shows the cutting hand tool with the handle 11 and the front part 15 where the blade is located in a recessed area 16. By placing the blade in the recessed area 16, it is protected, so that the blade 21 cannot accidentally cut objects or injure the operator. The narrow opening of the recessed area 16 in which the blade 21 is located prevents the accidental cutting of objects that have a thickness exceeding the width of the recess 16, such as the operators fingers, arms or other body parts.

Thin material such as film, paper, packaging or other flexible materials with a thickness that is less than that of the opening of the recessed area 16 can easily pass through the opening and be cut by the blade 21. In the embodiment shown in FIG. 1 the cutting hand tool is designed to be used in a pulling motion, so that the tool is placed at the far end of the material which is to be cut and pulled towards the operator. In another embodiment the cutting hand tool can be designed to have the recess 16 pointing towards the front part of housing 10, to allow cutting using a pushing motion.

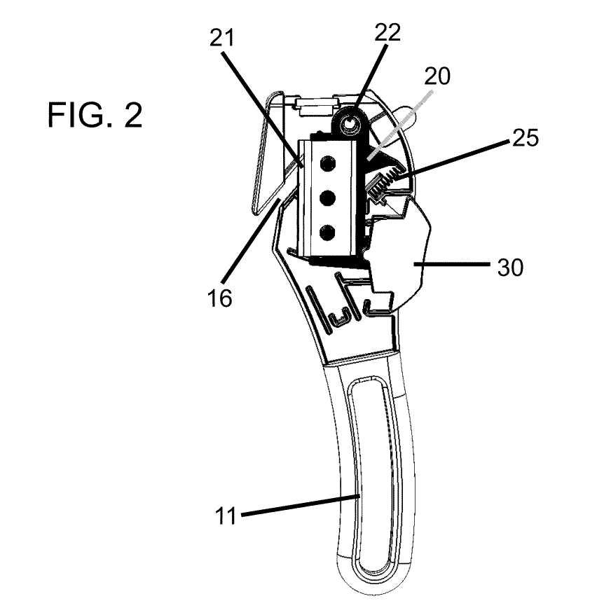

At the beginning of a cut frequently an additional initial force is required to start the cutting action, which is larger than the force needed to continue the cut after it has been initiated. This often occurs if the material has reinforced or thicker edges or if the material is rolled over or folded, creating several layers of thickness at one edge. Before a cut is initiated this leads to bunching of the material in front of the blade, which makes initiating a cut even more difficult. This well-known issue is quite common for goods which are packaged using shrink or stretch-wrap. Instead of applying a greater force to overcome the initial resistance, the presented cutting hand tool allows the operator to activate the trigger 30, which leads to a slight rotation of the blade holder 20 around the pivot point 22 located at the front of the cutting hand tool, causing a movement of the cutting blade 21 towards the material. As can be seen in FIG. 2 the location of the trigger button 30 is located at the rear end of the blade holder 20 and cutting blade 21 in order to increase the leverage.

In other embodiments the trigger button 30 can be located at other locations, for example if the recess 16 points towards the front part of the housing 10, the trigger button 30 can be located at the front of the cutting hand tool or an extension arm can be included to transfer the movement of the trigger button 30 to the front of the blade holder 20. In this further embodiment the pivot point 22 could be located at the rear end of the blade holder 20.

In these two embodiments the trigger button 30 is activated by squeezing the tool, however other mechanisms for activating the trigger such as a slide or a pull button, or a button located at a different location on the tool can be used.

The movement of the cutting blade 21 towards the material, which is caused by activating the trigger button 30 leads to a cut similar to the cut when using scissors. One part of the tool is essentially stationary while the cutting blade is moved towards the material. As soon as the cut is initiated by activating the trigger button 30, the cutting hand tool can be moved along the material, performing a cut as known from utility knives and concealed blade cutters. A spring 25 connected to the front part of the housing 15 immediately forces the blade holder 20 and the cutting blade 21 back to the original position as soon as the trigger button 30 is released.

If during the cut along the material the cutting blade 21 is blocked, as can occur when cutting rigid material or if the material is reinforced by a scrim, or if the material is stretchy and bunches or folds, the whole process of activating the trigger button 30 to perform the scissor-like cut can be repeated. As soon as the cut is initiated the hand tool can be moved along the material again, and the trigger button 30 can be released, so that the rest of the material can be cut easily.

This description and the accompanying drawings show exemplary embodiments of the invention. The invention, however, should not be interpreted as being limited to these particular embodiments. Variations of the embodiments can be made by those skilled in the art without departing from the scope of this invention as defined by the claims.

1. A cutting hand tool comprising
a housing,
consisting of a handle and
a front part
said front part
containing a narrow recess,
a blade holder,
mounted in said front part,
allowing movement of the blade edge between a first and a second position
an arrangement
forcing the blade holder into said first position,
a trigger button,
wherein
activating the trigger button forces said blade holder into a second position by moving the blade holder and with it the cutting blade such that the cutting edge of the blade moves at least partially in a direction other than the direction along the cutting blade edge.

2. The cutting hand tool of claim 1 wherein
said blade holder movement is by rotation around a pivot point.

3. The cutting hand tool of claim 1 wherein
said blade holder movement is by translation of the cutting blade.

4. The cutting hand tool of claim 1 wherein
said arrangement consists of at least one spring.

5. The cutting hand tool of claim 1 wherein
said arrangement consists of at least one magnet.

6. The cutting hand tool of claim 1 wherein
said narrow recess points towards the rear of the cutting tool to enable a cutting motion towards the operator

7. The cutting hand tool of claim 1 wherein
said narrow recess points towards the front of the cutting tool to enable a cutting motion away from the operator.

8. The cutting hand tool of claim 1 wherein
said arrangement consists of a mechanism for automatically moving the blade holder between the first and second position and said trigger button is used to start and stop the automatic movement.

9. The cutting hand tool of claim 8 wherein
the frequency of said movement of the blade holder between the first and second position is variable and can be adjusted.

10. The cutting hand tool of claim 8 wherein
the travel distance of the blade holder between the first and second position is variable and can be adjusted.

11. The cutting hand tool of claim 8 wherein
said mechanism includes a motor.

12. The cutting hand tool of claim 8 wherein
said mechanism includes an electromagnet.
